(19) United States
(12) Patent Application Publication
(10) Pub. No.: US 2020/0262550 A1
(43) Pub. Date: Aug. 20, 2020

(54) Encapsulated Drone

(71) Applicant: Viritose Corp., Pensacola, FL (US)

(72) Inventors: Michael Dailey, Austin, TX (US); Jerzy George Drean, Pensacola, FL (US)

(73) Assignee: Viritose Corp., Pensacola, FL (US)

(21) Appl. No.: 16/761,498

(22) PCT Filed: Nov. 5, 2018
(86) PCT No.: PCT/US18/59290

§ 371 Date: May 4, 2020

Related U.S. Application Data
(60) Provisional application No. 62/581,662, filed on Nov. 4, 2017.

(51) Int. Cl. B64C 27/20; B64C 27/10; B64C 39/02

(52) U.S. Cl. CPC B64C 27/20; B64C 27/10; B64C 39/024; B64C 2201/042; B64C 2201/162; B64C 2201/027; B64C 2201/22

(57) ABSTRACT

Embodiments of the present invention enable a user of a drone to operate it more quietly. Embodiments of the present invention relate to such a system, apparatus, and a method of and for a drone that may be quiet, that can fly far while minimizing the need to recharge, that may have protective shells, that may employ operational redundancy, that may provide stealth capabilities due, for example, to the design of the shell, and that may allow a drone to stay in position at, for example, 329,999 feet for months. In one embodiment of the present invention, electro-magnetism is used to propel a drone while another embodiment uses an expandable outer shell. The embodiments, while also increasing a drone's range, provide enhanced maneuverability due to the unique shape and drive and steering systems of the drone. Embodiments may provide stealth and overall convenience, together potentially resulting in increased safety to creating a class of sub-space vehicles.

This application claims both the benefit of an earlier filed provisional application, filed Nov. 4, 2017, identified as Application No. 62,581,662, and a PCT application, filed Nov. 5, 2018, identified as Application No. PCT/US18/59290, which claimed the benefit of said provisional application.

### BACKGROUND OF THE INVENTION

### 1. Field of the Invention

Embodiments of the present invention relate to a system, apparatus, and a method of and for a drone encapsulated by a multi-dimensionally protective shell, resulting in quiet operation, farther range minimizing the need to recharge (or re-power batteries), drone- and public-protection, and operational redundancy.

### 2. Description of Related Art

All over the world, drones are wildly popular. Diverse types of “users” (by way of non-limiting examples, personally, by enthusiasts, hobbyists, and individuals, and professionally, by governments, entities, and other organizations) operate drones.

As drones become ubiquitous, the chances increase that a drone may inadvertently or intentionally fly into a restricted air space. Examples of restricted airspace include airports, airplane flight paths, no-fly zones, buildings/skyscrapers, military reservations, stadiums, private property, and other geographic boundaries. The Federal Aviation Administration (FAA) and state agencies continue to develop more guidelines and regulations for drone operations of all kinds (civil, commercial, recreational, etc.) in the United States as well as other countries. However, presently, there are no systems that effectively prevent or otherwise restrict a drone from flying into restricted air space. There is also nothing that effectively prevents drones from being flown over private property.

Currently, drones are not very quiet. They cannot fly very far without the need to recharge. Special types of drones, including security drones, do not have well designed “shells” to protect critical flight components or protect from un-disrupted operations; rather, cages and ‘bumper-borders’ currently used that attach to drones only offer a modicum of protection. Typically, current drones use a multi-rotor configuration instead of a multi-motor configuration, the former lacking operational redundancy. Regardless, all drones currently used have their rotors externally placed and without any type of shell, which, in any permutation, decreases safety and aerodynamic efficiencies. Accordingly, users are limited to drones that merely offset flight direction based on wind variance or turbulence rather than redirecting most wind influence around the body of the drone. Further, drones carrying payloads may have their steering systems affected by the placement of their payloads relative to their rotors. These shortcomings owe to the design of current drones.

Drones suffer from further shortcomings in use. For example, because drones are conspicuous, particularly when making an approach for landing, and because the public is becoming more aware of the growing use of drones for various purposes, drones could become vulnerable to tampering. For example, the control of a drone might be intercepted or interfered with in-flight such as by intercepting, jamming, and/or imitating (e.g., pirate signals) global positioning or Global Navigation Satellite System (GNSS) signals in order to direct a drone to a surrogate landing zone. A drone may lose communications with a GNSS or other navigational system due to terrain features, dead spots, or GNSS outage, and may become lost, thereby putting the drone at risk. In some cases, repeated “hijacking” of drones in an area may lead to an inference that a particular area should be avoided. However, presently there is nothing that prevents drones from being flown into high-risk areas where hijacking is likely.

In light of the foregoing and other shortcomings in the art, it is desirable for users to operate drones that are quieter, can fly farther, can remain undetected, and increase safety, both to the user and the surrounding public and to the drone itself. Equipped with innovative in-flight technology, by way of non-limiting example, LED indicators inside or on the drone that make it easy (at a glance) to determine direction of flight, embodiments of the present invention are designed to fly using the simplest of hand held flight controllers, reducing the fatigue of learning to fly while promoting the actual entertainment and safety of flying a drone.

### BRIEF SUMMARY OF THE INVENTION

An embodiment of the present invention is of a drone mostly, if not entirely encapsulated by a multi-dimensionally protective shell while exposing only small/slim areas for intake, output, and steering functionality.

An embodiment of the present invention is of a drone including an expandable weatherproof rigid casing that may include an inflatable polymer rubberized bladder.

An embodiment of the present invention is of a drone including an expandable multi-blade group that may include a spring loaded rachet hub for multiple blade configurations.

An embodiment of the present invention is based on an advanced platform built to endure long flight periods and provide the ability to carry heavy payloads, quietly and efficiently.

Certain aspects of the present invention may provide solutions to the problems and needs in the art that have not yet been solved by currently available drones. For example, certain aspects of the present invention provide a system, apparatus and method for producing an encapsulated drone.

An exemplary embodiment of the present invention includes an apparatus, in a preferred embodiment with a zero-point gravity (ZPG) quiet drive.

Certain aspects of the present invention may provide solutions to the problems and needs in the art that have not yet been solved by currently available drones. For example, certain aspects of the present invention provide a system, apparatus and method for producing an encapsulated drone.

According to an aspect of the present invention, an encapsulated drone may be provided. The encapsulated drone may include a shell of the encapsulated drone. The encapsulated drone may further include a drive assembly at least substantially encapsulated by the shell. The drive assembly may include at least one motor, and a plurality of rotors powered by the at least one motor.

According to a second aspect of the present invention, a method for producing an encapsulated drone may be provided. The method may include providing a drive assembly including at least one motor and a plurality of rotors powered by the at least one motor. The method may further include providing a shell substantially encapsulating the drive assembly.

The foregoing and other aspects and advantages of the invention are illustrative of those that can be achieved by the various exemplary embodiments and are not intended to be exhaustive or limiting of the possible advantages which can be realized. Thus, these and other aspects and advantages of the various exemplary embodiments will be apparent from the description herein or can be learned from practicing the various exemplary embodiments, both as embodied herein or as modified in view of any variation which may be apparent to those skilled in the art.

### BRIEF DESCRIPTION OF THE DRAWINGS

In order that the advantages of certain aspects of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1A is a cross-section of a drone encapsulated by a multi-dimensionally protective shell according to an exemplary embodiment of the present invention.

FIGS. 1B-1E show views of rotors according to an exemplary embodiment of the present invention.

FIG. 2A is a cross-section of a drive assembly according to an exemplary embodiment of the present invention.

FIGS. 2B and 2C show exploded views of a drone with scalable and modular motors, therein, four, and in FIG. 2D, six motors, according to an embodiment of the present invention.

FIG. 3A is a view of the top of a drone showing air intake according to an exemplary embodiment of the present invention.

FIG. 3B is a view of the bottom of the drone of FIG. 3A, showing air exhaust.

FIG. 4A shows an exploded view of a steering disc and how air traverses the steering disc in operation with a mating cone and a linear rotary motor according to an exemplary embodiment of the present invention.

FIG. 4B shows an exploded view of a steering disc with a steering drive motor according to another exemplary embodiment of the present invention.

FIG. 4C shows an exploded view of a steering disc with a retracting control drive arm according to another exemplary embodiment of the present invention.

FIGS. 5A, 5B, and 5C show various embodiments of an encapsulated drone using a common magnetized shaft with various permutations of a counter rotating hub motor fan assembly group fixed to a common shaft creating a zero-point gravity drive according to exemplary embodiments of the invention. FIGS. 5D-G show an encapsulated drone according to an alternative embodiment of the present invention.

FIG. 6 is an (exploded) view of a magnetic hub assembly unit according to an exemplary embodiment of the present invention.

FIG. 7 shows another embodiment of an encapsulated drone without any magnetic hub assembly unit according to an exemplary embodiment of the present invention.

FIG. 8A shows another embodiment of an encapsulated drone with a zero-point magnetic hub assembly according to an exemplary embodiment of the present invention.

FIGS. 8B and 8C show an exploded view detailing the geared assembly of the zero-point magnetic hub assembly of FIG. 8A.

FIG. 9A shows a magnetic resonance power amplification (MRPA) pack with a steering skirt of an exemplary drone according to an exemplary embodiment of the present invention.

FIG. 9B shows a side view of FIG. 9A showing a range of motion of the steering skirt of FIG. 9A.

FIG. 10A is a bottom view of an exemplary drone revealing a fly wheel 1001 and an inflatable bladder according to an exemplary embodiment of the present invention.

FIG. 10B shows the exterior shell of the exemplary drone of FIG. 10A.

FIGS. 11A-B show a joystick and control arm in static and extended states that can control an exemplary drone according to an exemplary embodiment of the present invention.

FIG. 11C shows how the joystick can rotate or counter-rotate a mating cone in a drone according to an exemplary embodiment of the present invention.

FIGS. 12A-B shows successively exploded views of the magnetic resonance power amplification (MRPA) pack according to an exemplary embodiment of the present invention.

FIGS. 13A-B shows a payload mounting plate and exemplary holes for mounting said plate according to an exemplary embodiment of the present invention.

FIG. 14 is a schematic representation of a drone storage hub or nest according to an exemplary embodiment of the present invention.

### DETAILED DESCRIPTION

Reference will now be made in detail to embodiments of the present invention, examples of which are illustrated in the accompanying drawings, wherein like reference numerals refer to the like elements throughout. The embodiments are described below to explain embodiments of the present invention by referring to the figures.

It will be readily understood that the components of various embodiments of the present invention, as generally described and illustrated in the figures herein, may be arranged and designed in a wide variety of different configurations. Thus, the following more detailed description of the embodiments of a system, apparatus and method of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. By non-limiting example, reference throughout this specification to “an embodiment”, “certain embodiments,” “some embodiments,” “embodiments,” or similar language means that a particular feature, structure, or characteristic described in connection with the embodiment is included in at least one embodiment of the present invention. Thus, appearances of the phrases “in an embodiment”, “in certain embodiments,” “in some embodiment,” “in other embodiments,” “embodiments,” or similar language throughout this specification do not necessarily all refer to the same group of embodiments, and the described features, structures, or characteristics may be combined in any suitable manner in one or more embodiments.

As used in this application, the terms “a”, “an” and “the” may refer to one or more than one of an item. The terms “and” and “or” may be used in the conjunctive or disjunctive sense and will generally be understood to be equivalent to “and/or”. For brevity and clarity, a particular quantity of an item may be described or shown while the actual quantity of the item may differ. Features from an embodiment may be combined with features of another.

As used in this application, the term “including” (or any of its various forms such as include) means “including but not limited to” or without limitation, and said term is synonymous of and with “e.g.,” “for example,” “by way of non-limiting example,” and “such as;” whereas “consisting” (or any of its various forms such as consist) means limited to a particular group or subset, and said term is synonymous of and with “for specific example only.” The terms “e.g.” and “for example” are meant to be illustrative and non-limiting.

As used in this application and unless qualified, any reference to rotor or rotor blades may be interchangeable to either or both. Further, when an element is described as “connected,” “coupled,” “attached” or otherwise linked to another element, it may be directly linked to the other element, or intervening elements may be present.

An exemplary embodiment of the present invention is of a drone where the entire drive assembly and the other parts of the drone are mostly, if not entirely, internally encapsulated in one or more shells. Said encapsulation protects the drone itself, including by way of non-limiting example, said drive assembly (including any rotor blades) and other internal flight systems from external forces (e.g., elements of weather such as hail, man-made attempts to disrupt operations such as anti-drone netting and ramming), disturbances (e.g., signal interference), and physical obstacles (e.g., trees, buildings, humans and animals). Said encapsulation also protects living things, including people, including users themselves, and inanimate things, including buildings and power lines. Said encapsulation may also provide for a smooth aerodynamic body that translates to greater operational efficiencies, including speed.

The drive assembly of embodiments of the present invention may allow for the addition of multiple motors to drive a variable number of rotor blades (or simply, rotors), a configurable redundancy which secures no gap in flight operations and the ability to scale torque/lift without the need of special modification.

An embodiment of the present invention may have scalability of motors from, for example, two to eight motor configurations using motor ports that house each motor in a single layer, or even stacked layers of motors.

An embodiment of the present invention can employ shells made from various materials suitable for a particular task. By way of non-limiting example, for security or other defensive or even offensive purposes, a shell could be made with stealth materials (or radar-absorbent materials (RAM)) that will hide or limit the ability of a non-user to locate the location of a drone. For drone transport through areas with fire or nuclear radiation, a shell could be made with fire-retardant materials or those that repel, diminish (or assess) nuclear radiation.

According to another embodiment of the present invention a drone's shell may employ one of many specialized covers, each cover being suitable for a particular task.

An exemplary embodiment of the present invention may include a smooth and mostly, if not entirely rounded shell.

Other embodiments of the present invention may include shells that have different shapes and textures that could affect, by way of non-limiting example, stealth and aerodynamic properties. The surface, inner or outer, of a shell can be layered with assistive material according to specified mission and operational requirements.

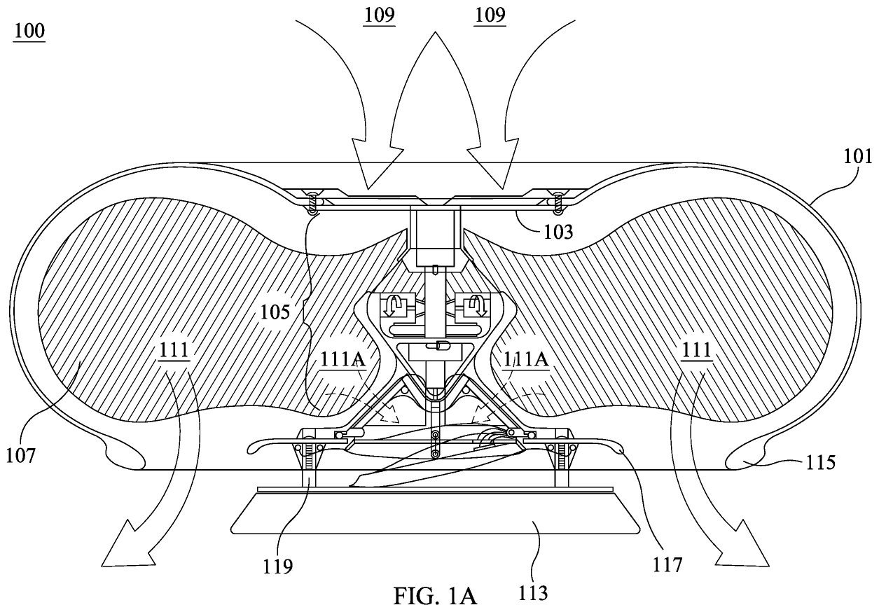

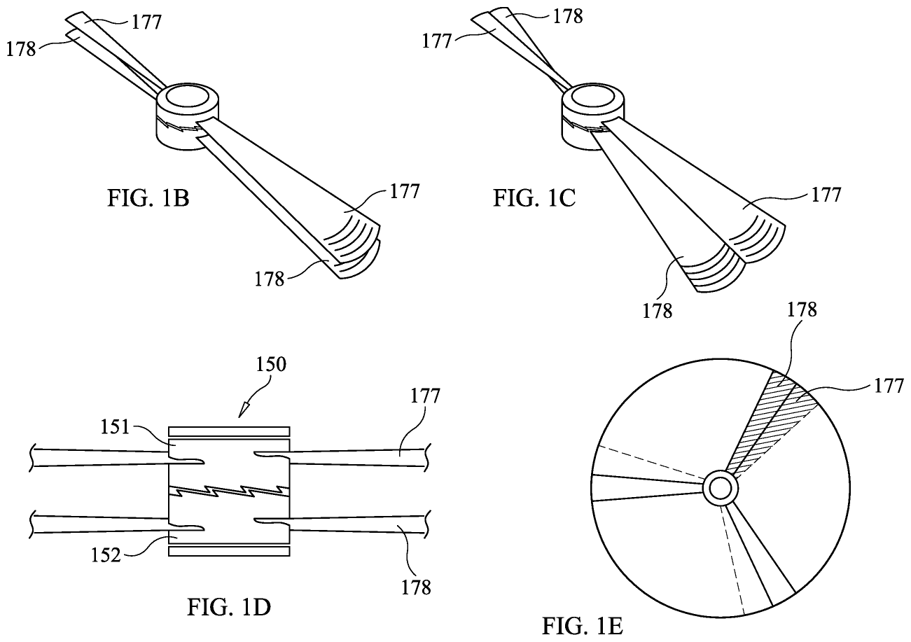

FIG. 1A is a cross-section view of an exemplary drone 100 encapsulated by a multi-dimensionally protective shell 101 according to an exemplary embodiment of the present invention. The drone 100 may include a drive assembly 105 (connected to said shell 101 via a cross-bar support 103), a power assembly housing 113 and rotors 107 positioned inside the shell 101 that produce lift from air that enters 109 said drone via openings in shell 101 that gets forced through an exit 111 that may include edges comprising, specifically, an exhaust outer lip 115 and an exhaust inner lip 117, which may be in communication with a base stabilizing strut 119. Air may exit one or more openings 111A and may steer and direct the drone 100. In an embodiment, the drone 100 may have an air shield or spoiler emanating at various angles from the exhaust inner lip 117 and which may extend to the shell, including the exhaust outer lip 115.

The shell 101 of the drone of FIG. 1A may have almost unlimited overall dimensions, with one embodiment ranging from 6 inches in diameter to 36 inches in diameter. The shell 101 may be formed of plastic. As noted above, the shell may be made from various materials. For example, the shell may be made from one or more composite materials such as carbon fiber-reinforced polymer.

Rotors 107 may take any appropriate configuration and may be connected to the drive assembly 105. Different types and configurations of rotors are shown herein such as those shown in FIG. 1A and the multilayer configurations shown in FIGS. 1B-E, 5A-C, and 7. As one exemplary configuration, rotors may be connected to a rotating hub carrier of the drive assembly 105. In the embodiment of FIG. 1, the rotors 107 collectively substantially fill the space defined within the shell 101. The number of rotors, size of each rotor, and design of each rotor may take various forms. In an embodiment, one or more rotors may include “a bump” or one or more grooves; that is, the shape of the rotors and the use of grooves on the surface thereof may be configured to motivate or usher more airflow thereby increasing lift efficiency. Further, grooves or other surface features, for example, air control veins, may be included within the shell for directing and stabilizing airflow. In an embodiment, a set of rotors may be interchangeable with one or more additional sets of rotors, i.e., they can be modular. For example, the rotors may detach from the hub carrier. Alternatively, a hub carrier and set of rotors may be removed as a set and a separate set may be installed in the same drone. Different sets of rotors with, for example, different pitches, may have distinctive characteristics (such as lift characteristics) and therefore may be interchanged depending on flight objectives or other desired goals. Rotors may be adjustable in terms of pitch and/or size (e.g., surface size). For example, the exemplary embodiments of FIGS. 1B-E may include an upper layer of rotors 177 and a lower layer of rotors 178. In a narrowed configuration shown schematically in FIG. 1B, upper rotors 177 are directly above lower rotors 178 thereby effecting or simulating a smaller blade surface area size. In an expanded configuration shown schematically in FIG. 1C, the upper rotors 177 are adjusted relative to the lower rotors 178 to effect or simulate a larger blade size. It will be appreciated that any number of positions (e.g., partially expanded) are possible and considered to be within the scope of the present invention. The narrowed configuration may be appropriate for increasing speed while the expanded configuration may be more appropriate for conserving energy. FIG. 1D is a top view showing the expanded configuration relative to the narrowed configuration. As can be observed, when the upper rotors 177 are adjusted relative to the lower rotors 178, a larger effective blade surface area size results. The blades may be adjusted relative to one another by various mechanisms. For example, as shown in FIG. 1E, a spring loaded rachet hub assembly 150 may include an upper rotor hub 151 and a lower rotor hub 152 that may be secured relative to one another by a ratchet mechanism including a gear and paw, or interlocking gears. Alternative assemblies may include rotors being spring-loaded, magnetically controlled, or moved via linear actuator relative one to another, relative top to bottom (in a multilayer embodiment), or relative to itself in the case of a single rotor expanding. Alternative embodiments may include rotors that are each rotatable so as to adjust pitch of the blades.

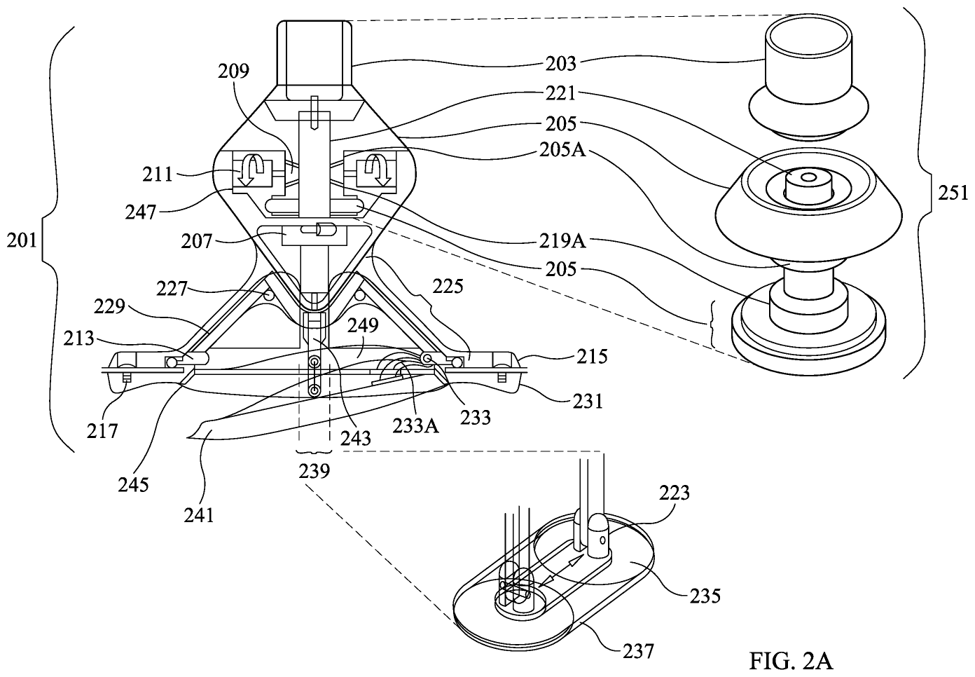

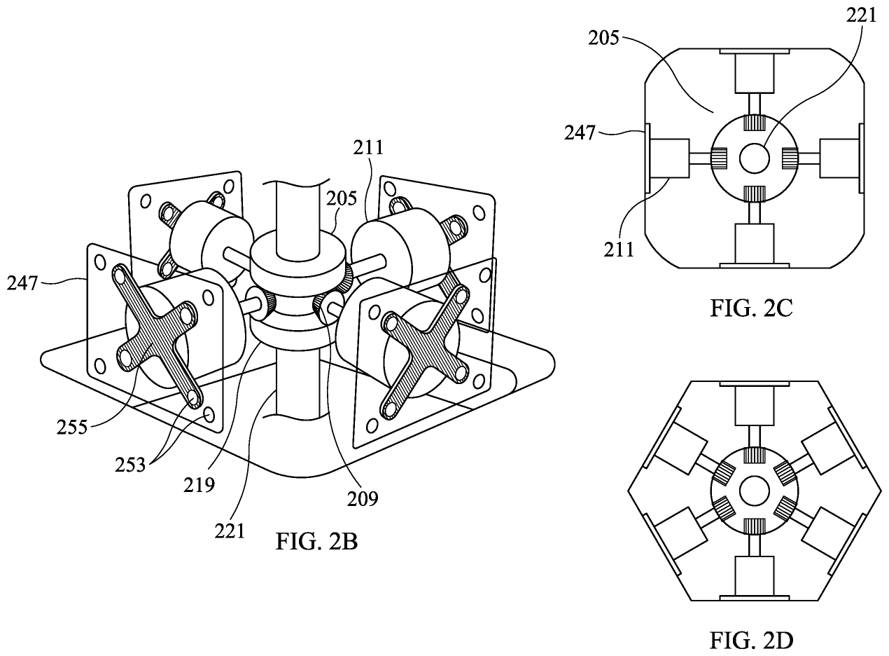

FIG. 2A is a cross-section of a drive assembly 201, such as the drive assembly 105 of FIG. 1. FIG. 2A has an exploded view of a rotating hub carrier assembly 251 with a further exploded view of a steering disc control arm hinge assembly 239. Turning first to the view of the rotating hub carrier assembly 251, the drive assembly 201, which could be controlled by a microprocessor 207, may include a mating collar 203 that may connect to a cross bar support, such as the cross-bar support 103 of FIG. 1A that attaches to the shell. A center stem 221 may be connected to and extend from the mating collar 203 downward and provide an axis about which further components may be arranged. It should be noted at this point that terms such as “downward”, “under”, “above”, and the like are relative and are provided for the convenience of the reader and not necessarily by way of limitation. As noted above, the features, structures, or characteristics of the invention described throughout this specification may be combined in any suitable manner in one or more embodiments.

Turning back to FIG. 2A, the drive assembly 201 may further include a hub carrier 205 arranged along the axis of the center stem 221. In an embodiment, the center stem may be fixed and the hub carrier 205 may rotate about the axis of the fixed center stem 221. The hub carrier 205 may be arranged under the mating collar 203 and above motors 211. The hub carrier 205 may include a hub carrier geared collar 205A at a lower portion of the hub carrier 205.

The drive assembly 201 may include a housing (e.g., superstructure) that may house additional components. For example, the housing may house a motor mounting plate 247 and related components, as discussed below.

The drive assembly 201 may include the motor mounting plate 247 (or plates) seating one or more motors 211. The motor mounting plate 247 may be fixedly attached to the housing (e.g., superstructure) of the drive assembly 201. The one or more motors 211 may be operably connected to the hub carrier geared collar 205A of the hub carrier 205 by one or more motor gears 209. In an embodiment, the motor gears may be beveled. In another embodiment, the motor gears may be standard. In operation, the one or more motors 211 may rotate thereby rotating the one or more motor gears 209 thereby rotating the hub carrier geared collar 205 (and the attached hub carrier 205) in a first direction around the axis of the center stem 221.

The drive assembly 201 may include a counter rotating weight 219 arranged along the axis of the center stem 221. The counter rotating weight 219 may rotate about the axis of the center stem 221. The counter rotating weight 219 may be arranged under the motor mounting plate 247. The counter rotating weight 219 may include a counter rotating weight geared collar 219A at an upper portion of the rotating weight 219. In operation, the one or more motors 211 may rotate thereby rotating the one or more motor gears 209 thereby rotating the counter rotating weight geared collar 219A (and the attached rotating weight 219) in a direction opposite the rotational direction of the hub carrier 205. This opposite rotation accounts to the placement of the counter rotating weight geared collar 219A opposite to the hub carrier geared collar 205A relative to one or more motor gears 209.

Turning to FIGS. 2B and 2C, a four motor 211 embodiment is shown. The number of motors may be scalable and may be modular. For example, a single motor 211 may be provided, two motors 211 may be provided, or three motors 211 may be provided. FIG. 2D shows an embodiment where 6 motors may be provided. Alternative numbers of motors are contemplated (e.g., 5, 7, 8, 9, 10, etc.) and may be within the scope of the present invention.

Turning back to FIGS. 2B and 2C, the motors 211 may be attached to a motor mounting plate 247 (or plates) via a motor mount 255 and motor mounting holes 253. For example, the motors 211 may be attached to a vertical portion of the motor mounting plate 247. The motor mounting plate 247 may be fixedly attached to the center stem 221. Motors 211 may be in communication with a rotating hub carrier via a motor gear 209 and a counter rotating weight 219. As indicated, stacked layers of motors may be possible. For example, the motor mounting plate (or plates) may be dimensioned such that a second layer of motors may be fixedly attached to the vertical portion of the motor mounting plate. The second layer of motor(s) may be in communication with the rotating hub carrier via, e.g., a second motor gear and counter rotating weight. Additional layers may be added beyond a second layer. Additional motors may provide additional torque. Additional motors may require modification to the design of the drive assembly (such as of the hub carrier) and may affect overall size. The determination of whether to include multiple layers of motors maybe based on payload and size requirements.

Turning back to FIG. 2A, one or more micro-processing control boards 207 may be provided as part of the drive assembly 201. The micro-processing control board 207 may provide radio or other wireless communication with a radio transceiver providing operating commands for the drone. Additionally, and alternatively, the micro-processing control board 207 may include or be connected to memory containing pre-stored operating commands for the drone. The micro-processing control board 207 may provide commands, signals, or the like for controlling other elements of a drone 100, such as the speed of the one or more motors 211 and components of the steering assembly 225 (discussed below).

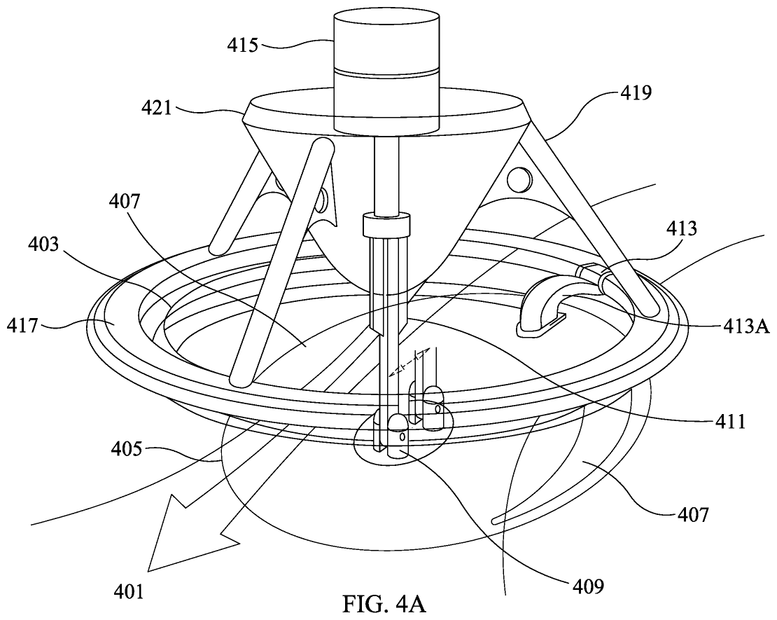

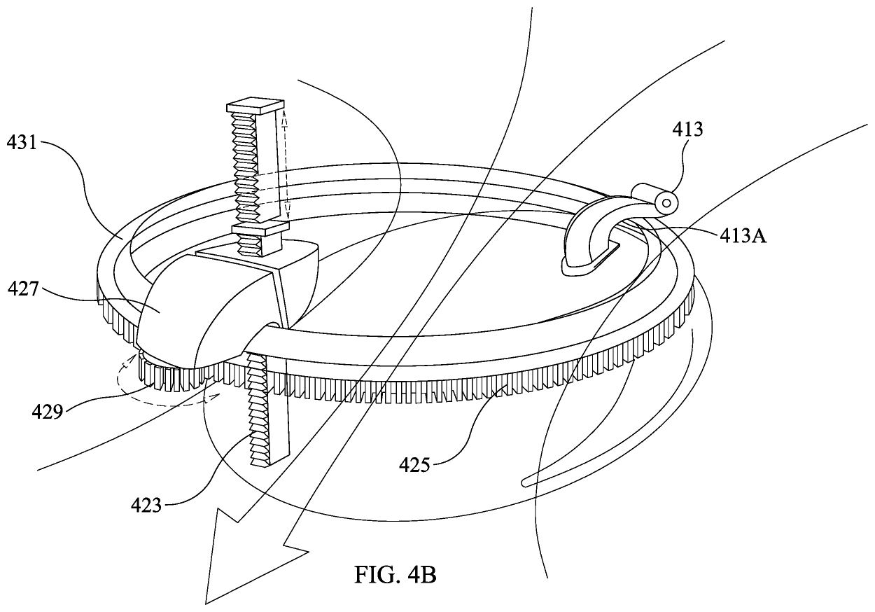

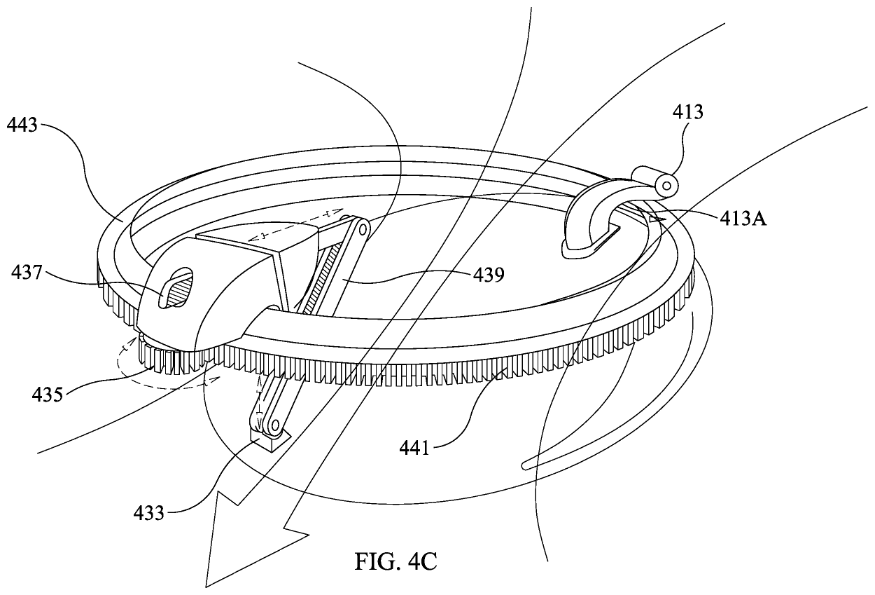

Turning next to the view of the steering disc control arm hinge assembly 239, a drone, such as the drone 100 of FIG. 1, may be provided with a steering disc 241. A top surface of the steering disc 241 may include features such as raised edge directional airflow guides 249, which, for example, could also be a flexible or cloth membrane, to direct airflow. A steering assembly 225 may include one or more steering disc support arm struts 227, each fixedly connected to a steering assembly support arm 229. The steering assembly support arms 229 may be fixedly connected to a steering assembly guide ring 213, which may be connected to a drive assembly base top mounting ring 215 which may be connected by drive assembly base mounting screws 217 to a drive assembly base under mounting ring 231. The steering assembly support arms 229 may be fixedly connected to a steering assembly mating cone (such as the steering assembly mating cone 421 as seen in FIG. 4A).

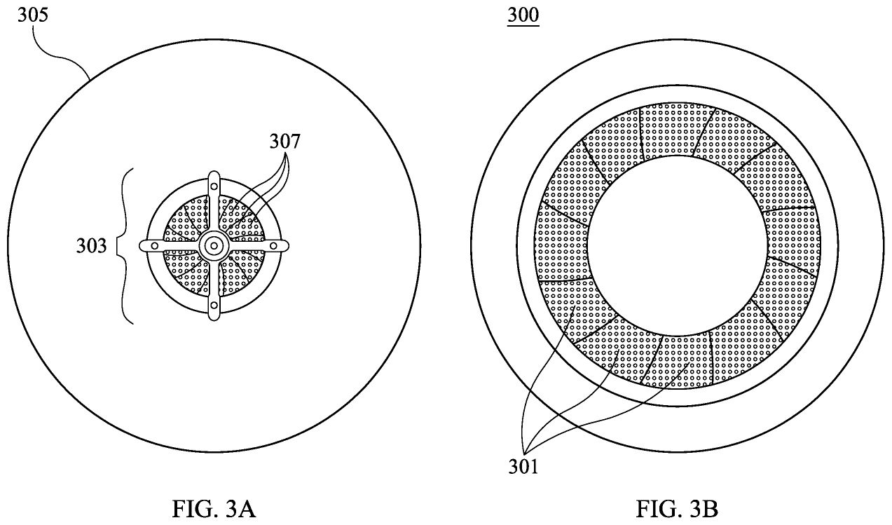

The steering disc 241 may be attached to the rest of the drive assembly 201 via the steering disc control arm hinge assembly 239 and a steering disc hinge arm 233A. The steering disc control arm hinge assembly 239 may include a steering disc control arm foot 235 (on top of the steering disc 241) connected to a steering disc control arm foot hinge 223, hindgedly connected to a steering disc control arm 243. It is again noted that terms such as “connected to” should be broadly interpreted to include direct connection and connection through intervening elements. The steering disc hinge arm 233A (connected to the top of the steering disc 241) may be hindgedly connected to the steering assembly guide ring 213 via steering disc hinge 233. The steering disc hinge 233 and arm 233A can be made of almost any material, including hard plastic or light-weight aluminum. In operation, air flows through a drone, such as drone 100 of FIG. 1, by entering 109 via openings in the top of the shell 101, avoiding or mostly avoiding the steering disc 241 since a steering disc seating seal ring 245 or other mechanism may prevent leakage of air flow through the steering disc 241, a result which would affect direction of the drone, and exiting 111 the bottom of the shell 101, thereby providing lift. Air may exit 111A over the steering disc 241 when the disc control arm hinge assembly 239 is activated, causing the steering disc arm foot hinge 223 and foot 235 to move along the steering disc arm track 237, thereby providing lift and forward (or sideways or reverse, or some combination thereof) thrust. These operations are discussed next with respect to FIGS. 3A, 3B, 4A, 4B, and 4C.

FIG. 3A is a view of the top of a drone 300, such as drone 100 of FIG. 1, showing air intake, or more specifically top intake open area 307 according to an exemplary embodiment of the present invention. FIG. 3B is a view of the bottom of the drone 300 of FIG. 3A, showing air exhaust, or more specifically bottom exhaust open area 301. The top intake open area 307 is located on the top of the shell 305 of the drone 300. In operation, rotation of rotors within the drone 300 draws in air through the top intake undeveloped area 307 past a cross bar support 303, such as the cross-bar support 103 of FIG. 1, and forces air out through the bottom exhaust open area 301 around a steering disc.

FIG. 4A shows an exploded view of a steering assembly (such as the steering assembly 225 of FIG. 2A with its steering disc 241) and a steering disc 405 of a drone, such as drone 100 of FIG. 1, and how air traverses the steering disc 405 in operation with a steering assembly mating cone 421 and a linear rotary motor 415 according to an exemplary embodiment of the present invention. A steering disc seating seal ring 403 (such as the steering disc seating seal ring 245 of drone 100 of FIG. 1) or other mechanism may be provided to prevent leakage of air flow through the steering disc 405, a result which would affect control of the drone. A top surface of the steering disc 405 may include features such as raised edge directional airflow guides 407 (such as such as raised edge directional airflow guides 249 as found in FIG. 2A) that direct airflow 401. The steering disc 405 may be connected to a drone, such as drone 100 of FIG. 1, by a steering disc hinge arm 413A and a steering disc control arm 411. The steering disc hinge arm 413A may be connected at one end to the steering disc 405 and at the other may be hindgedly connected to the drone by a steering disc hinge 413. The steering disc control arm 411 may be connected at one end to the steering disc (such as by a steering disc control arm foot connected to a steering disc control arm foot hinge 409) and at the other end may be connected to the linear rotary motor 415, which causes both a steering assembly guide ring 417 (such as the steering assembly guide ring 213 of FIG. 2A), which may be attached to the steering assembly mating cone 421 via steering assembly support arms 419 (such as the steering assembly support arms 219 of FIG. 2A), to rotate.

The steering disc hinge arm 413A and steering disc hinge 413 enable the steering disc 405 to rotate from a horizontal position to almost any angle, including approximately 20 degrees. The rotation of the steering disc about the steering disc hinge 413 is limited by the steering disc control arm 411 which is connected to the steering disc by a steering disc control arm foot and hinge. The foot may slide in a track allowing for movement. The steering disc may rotate completely (i.e., 360 degrees) about the steering disc seating seal ring 403.

In an embodiment, instead of the hinge 413, the steering disc 405 could be cone shaped and uses a plunger mechanism from the center of the steering disc 405.

In operation, when the steering disc 405 is horizontal, airflow 401 is completely or substantially directed toward the rotors and outward away from the disc where airflow 401 exits a bottom exhaust open area, such as the bottom exhaust open area 301 of FIG. 3B. Airflow coming out of the bottom exhaust open area is directed downward thereby resulting in no or little forward movement of the drone. As the steering disc 405 is rotated to an increasing angle, airflow 401 is directed in one direction (such as in the direction of the arrow shown in FIG. 4A) causing thrust in the same direction (along with downward thrust) resulting in the drone movement in the opposite direction (in the direction opposite the arrow shown in FIG. 4A). The mating cone 421 may provide directional control of air relative to the steering disc 405 as the linear rotary motor 415 rotates the steering disc 405 (from a horizontal position), which controls the angle of the steering disc assembly and rotates said mating cone 421. In operation, the steering disc provides benefits. For example, while payload weight thresholds may need to be considered when looking at maneuverability, a drop-down steering disc may be above the payload resulting in velocity current not being hindered.

FIG. 4B shows an exploded view of a steering disc with a steering drive motor 427 according to another exemplary embodiment of the present invention. The steering disc may be connected to a drone, such as drone 100 of FIG. 1, by a steering disc hinge arm 413A and an articulating control arm 423. The steering disc hinge arm 413A may be connected at one end to the steering disc 405 and at the other may be hindgedly connected to the drone by a steering disc hinge 413. The articulating control arm 423 may be connected at one end to the steering disc and at the other end may be connected to the steering drive motor 427. The steering disc hinge arm 413A and steering disc hinge 413 enable the steering disc to rotate from a horizontal position to an angle of approximately 20 degrees. The rotation of the steering disc about the steering disc hinge 413 is limited by the distance that the articulating control arm 423 is able to travel, which in an embodiment, may be a function of the length of the articulating control arm 423.

To provide for steering control, the steering disc may rotate 360 degrees thereby directing the airflow in the direction opposite which the drone is to travel. A geared steering collar ring 425 may be provided under a steering drive motor collar 431. The geared steering collar ring 425 may rotatably mate with a steering drive motor guide gear 429 of the steering drive motor 427. The steering drive motor 427 may rotate clockwise or counterclockwise thereby rotating the steering drive motor guide gear 429. As the steering motor guide gear 429 rotates, the steering disc may rotate due to the steering drive motor guide gear 429 rotating against the geared steering collar ring 425.

FIG. 4C shows an exploded view of a steering disc with a retracting control drive arm 437 according to another exemplary embodiment of the present invention. The steering disc may be connected to a drone, such as drone 100 of FIG. 1, by a steering disc hinge arm 413A and an articulating control link 439. The steering disc hinge arm 413A may be connected at one end to the steering disc 405 and at the other may be hindgedly connected to the drone by a steering disc hinge 413. The articulating control link 437 may be connected at one end to the steering disc (such as by a steering disc hinge 433)) and at the other end may be connected the retracting control drive arm 437, which in turn may be connected to the steering drive motor 427. The steering disc hinge arm 413A and steering disc hinge 413 enable the steering disc to rotate from a horizontal position to an angle of approximately 20 degrees. The rotation of the steering disc about the steering disc hinge 413 is limited by the distance that the retracting control drive arm 437 is able to travel and the length of the articulating control link 439. In an embodiment, the distance that the retracting control arm is able to travel may be a function of the length of the retracting control drive arm 437. To provide for steering control, a geared steering collar ring 441 may be provided under a steering drive motor collar 443. The geared steering collar ring 441 may rotatably mate with a steering drive motor gear 435 of a steering drive motor, which may rotate clockwise or counterclockwise thereby rotating the steering drive motor gear 435 and ultimately the steering disc.

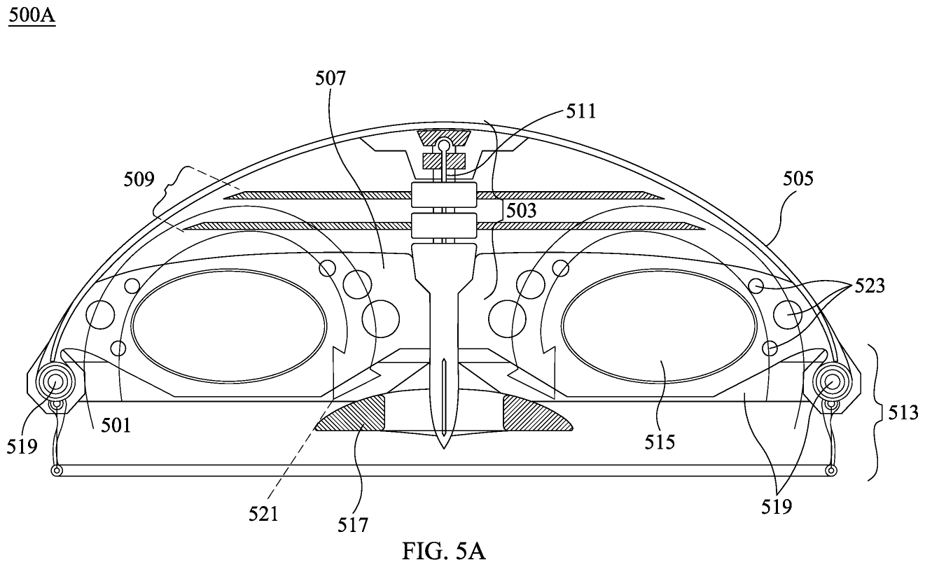

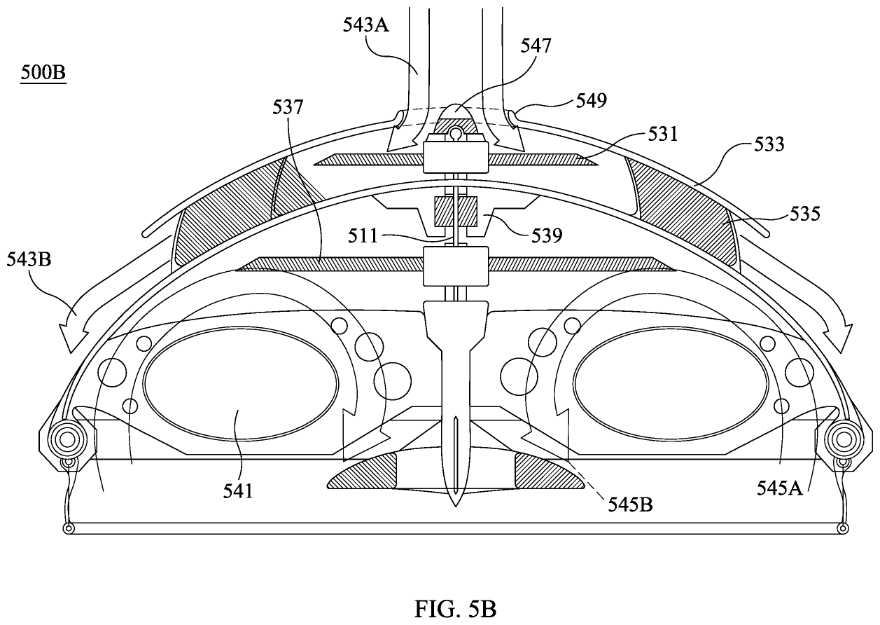

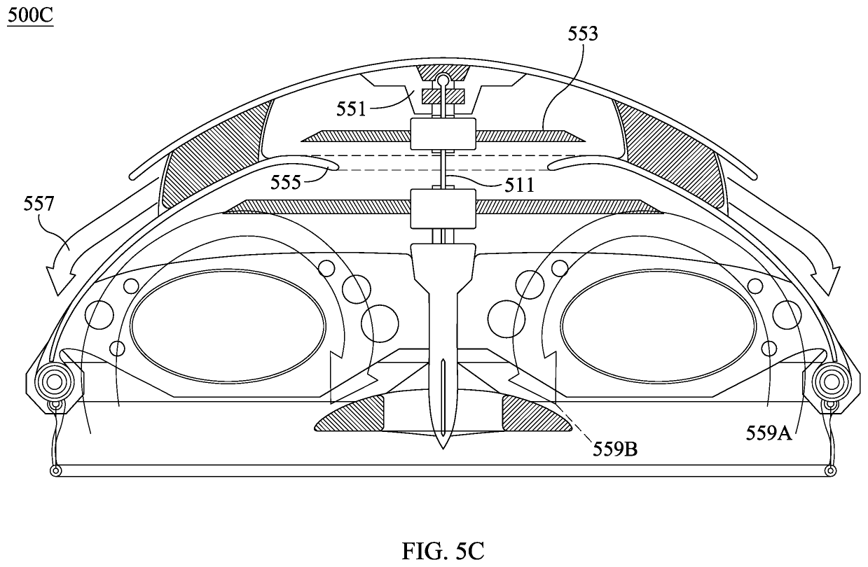

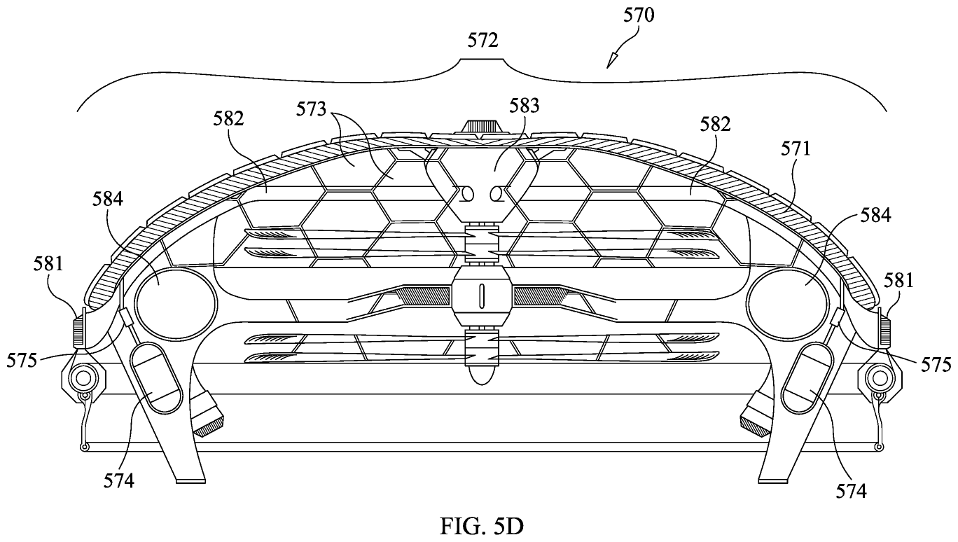

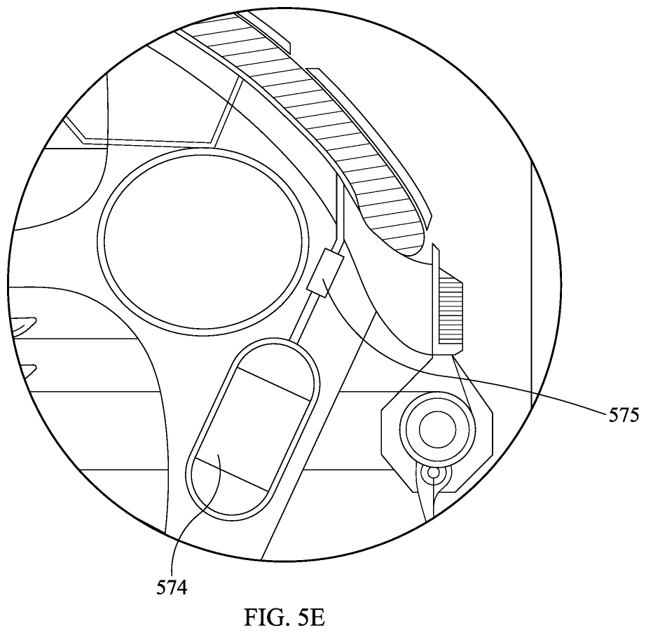

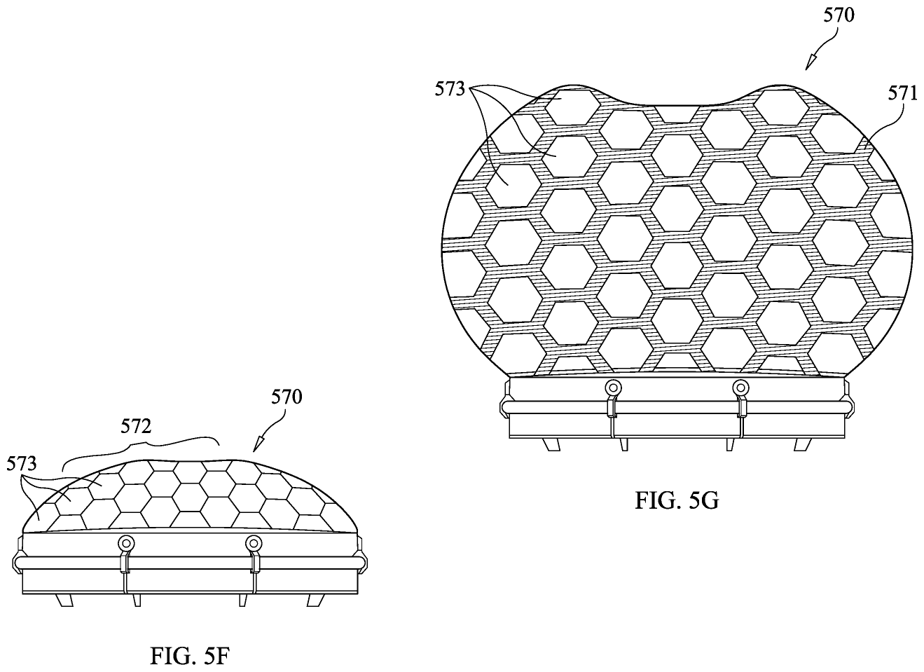

FIGS. 5A-C show various embodiments of an encapsulated drone using a common magnetized shaft 511 with various permutations of a counter rotating hub motor fan assembly group fixed to a common shaft creating a zero-point gravity drive, according to exemplary embodiments of the invention. In FIG. 5A, the drone 500A may include a rigid membrane outer skin 505 and a common magnetized shaft 511, for example, with two ball caps fixed at both ends. The rigid membrane outer skin 505 may include or be attached to a battery location 519 (for a battery). The drone 500A includes a main housing superstructure 503 for two hub motor fan assemblies and a zero-point magnetic bearing. The drone 500A may include an inner superstructure 507 that may be formed of Acrylonitrile Butadiene Styrene (ABS) plastic and may be die cut or injection molded. The inner superstructure 507 may include superstructure weight-saving cutouts 523 that can be almost any shape, including round. Encapsulated drones according to the present embodiments may include one or more bladders for various purposes. For example, a bladder may be internal and used for air compression. As another example, a bladder may contain gas to, e.g., help the drone to achieve a higher operational ceiling capability. For example, the inner superstructure 507 may include a bladder control plenum 515 for compression of uni-directional airflow. The bladder control plenum may be Mylar, which may contain gas, including helium, and may be inflatable. The drone 500A may include a counter rotating hub motor fan assembly group 509 arranged along an axis of the common magnetized shaft 511. The drone 500A may include a rotating fly wheel 517 fixed to a hub motor arranged along the common magnetized shaft 511. The drone 500A may further include a steering assembly 513. The steering assembly 513 may contain a flexible skirt fixed to an outer parameter of the drone 500A. In operation, incoming air 501 flows over the bladder control plenum 515 thereby being compressed before becoming outgoing air 521.

In FIG. 5B, the drone 500B may include an external shroud collar 533 (or plenum) at least partially covering an exterior fan assembly 531 that may result in a “Coanda” layout. The external shroud collar 533 may include an external shroud opening 549 and may be attached to a shell of the drone 500B by a structural gusset 535, thus providing configurable space for air flow. A magnetic cap 547 may be placed atop or at the end of a shaft. The drone 500B may include a magnetic carriage bearing group 539 arranged along the shaft, and an interior fan assembly 537 also along the shaft under the magnetic carriage bearing group 539. The drone 500B may include a bladder 541 that may be, for example, formed of Mylar and that may be inflatable. In operation, two main airflows may be defined. The rotors may result in incoming air 543A. Incoming air 543A may be pushed out 543B by exterior fan assembly 531. Incoming air 545A flows over the bladder 541 and may thereby be compressed before being blown out 545B by the interior fan assembly 537.

In FIG. 5C, the drone 500C may include a magnetic carriage bearing group 551 arranged along a shaft. While reducing the “Coanda Effect,” the drone 500C may have a completely encapsulated (top) shell that may include an upper shroud fan assembly 553 and an interior shell opening 555. In operation, incoming air 559A may be blown out 559B by the upper shroud fan assembly 553 or may flow over a bladder and may thereby be compressed before being blown out 559B by an interior fan assembly.

In FIGS. 5D-G, another exemplary bladder is shown in another exemplary encapsulated drone enabling an expandable shell. More specifically, an encapsulated drone 570 may include an inflatable reinforced bladder 571. The inflatable reinforced bladder 571 may be fixed (packed) to a shell or housing 572. In the embodiment shown, the shell or housing 572 may be formed of rigid shell components such as tiles or breakaway tiles 573 that may space apart from each other upon inflation or deployment of said bladder 571. The bladder 571 may be formed of expandable materials. For example, the bladder 571 may be a polymer rubberized inflatable reinforced bladder. The walls of said bladder may be thin enough for their application explained herein, yet thick enough for strength. For example, the bladder walls may be, for example, 6 mils thick.

As shown in FIG. 5F, the inflatable bladder 571 is not deployed or inflated, and therefore the tiles 573 may provide, for example, a rigid weatherproof shell (or portion thereof). The tiles may appear interlocked but may in fact be separated by a thin space. In an alternative embodiment, the tiles 573 may in fact interlock for support and the bladder 571 may be affixed to a back surface of the titles 573. As shown in FIG. 5G, the inflatable bladder 571 is deployed or inflated and therefore the tiles 573 are spread apart from one another. As shown, the outer shell 572 may expand outward and the shell may become a convex semi-hemispherical shape.

Turning back to FIGS. 5D and E, the encapsulated drone 570 may include one or more gas cartridges 574 connected by a check valve 575 to the interior of the inflatable bladder 571. The gas cartridges 574 may be formed of any appropriate material, such as, for example, aluminum. The gas cartridges 574 may contain gas or gases therein such as Helium (He) or any mix thereof. The check valve 575 may be opened (e.g., by remote operation, by sensor operation (such as by atmospheric pressure), by programming) to deploy or inflate the bladder 571. The check valve 575 may automatically inflate at a predetermined altitude (e.g., at or under 50,000 feet). Once filled, the bladder 571 may elevate the drone 570 to an appropriate altitude such as 329,999 feet, which is just below 100 kilometers (or around 62 miles), which represents the boundary between Earth's atmosphere and outer space (i.e., the Karman line). As further shown, stems also may be used in connecting the gas cartridges 574 to the interior of the inflatable bladder 571. In an embodiment, release of helium or gas from the inflated bladder 571 may be accomplished using a check valve like mechanism, like check valve 575 (e.g., using similar controls) so as to return the drone or position the drone for return by deflating the bladder 571.

The encapsulated drone 570 may include additional maneuvering mechanisms. For example, an ion thruster may be used for maneuvering at high altitudes. The encapsulated drone 570 may include one or more vector thrusters. The

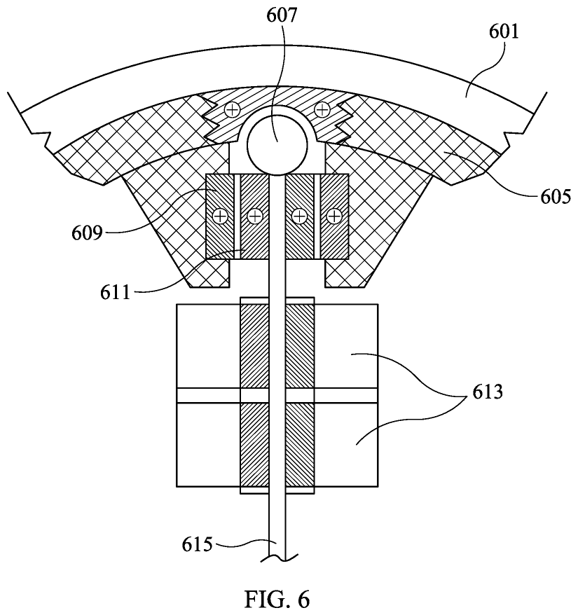

FIG. 6 is an (exploded) view of magnetic hub assembly unit 600 according to an exemplary embodiment of the present invention. The magnetic hub assembly unit 600 may be placed within a drone having a rigid membrane outer skin 601, i.e., a shell. The magnetic hub assembly unit 600 may be a part of a ZPG drive, such as the main housing super structure 503 of FIG. 5A. The magnetic hub assembly unit may include a magnetic bearing and/or proprietary collar design in a magnetic field hub-end caps or collar designed to capture specified mass (axle), and hold it in place within a magnetic field as specified. The ZPG drive end caps or collar may be designed to minimize contact friction with the use of repelling magnetic fields. The ZPG drive may consist of two major components: first, the receiver and anchor of a specified material and assembly matrix that hold or retain a magnetic field that may be fixed to a specific structural area. Second; a magnetic ball 607 of a specified size, shape, and magnetic strength of the same polarity field that may be fixed to both sides of an output shaft 615 as specified (axle). Two or more magnetic bearing or as specified to be fixed to shaft 615 (axle) as needed may be required to maintain balance integrity under inertia load. In an embodiment, a magnetic hub assembly machined end cap 603 may be provided above a magnetized ball cap 607 at one end of the shaft 615. The magnetic hub assembly machined end cap 603 may be made of a Neodymium magnet. The magnetic hub assembly machined end cap 603 may be located within or surrounded by a superstructure 605. The superstructure 605 may be, for example, formed of ABS plastic and may be die cut or injection molded. The magnetic hub assembly unit 600 may include an outer magnetic bearing ring collar 609, and an inner magnetic bearing 611 surrounding the shaft 615. The outer magnetic bearing ring collar 609 may be a Neodymium magnetic bearing ring collar. The inner magnetic bearing 611 may form a carriage magnetic bearing group and may be formed of a Neodymium magnet. The magnetic hub assembly may further include a counter rotating hub motor fan assembly group 613.

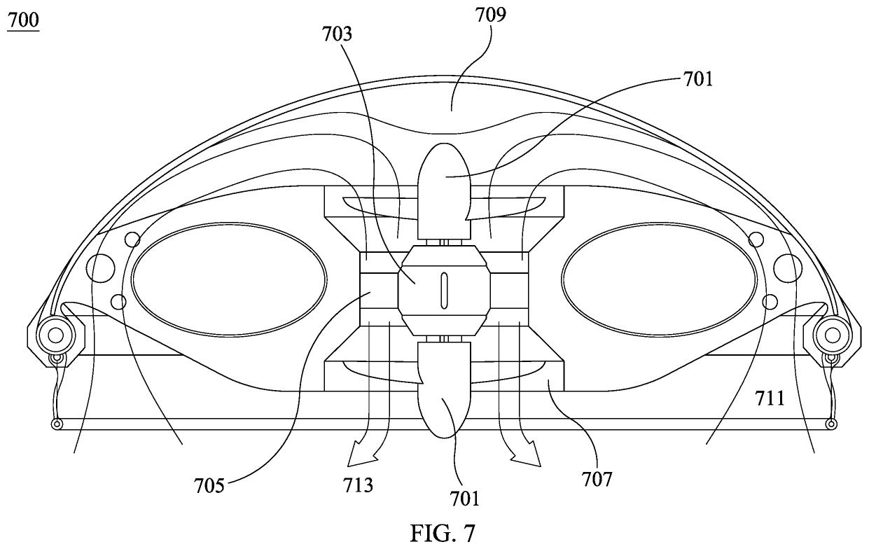

FIG. 7 is a schematic representation of an encapsulated drone 700 without any magnetic hub assembly unit, according to an exemplary embodiment of the present invention. The drone 700 may include a counter rotating fan assembly 701 and a diffuser node 709. A spar support arm 705 may support motor housing 703 which may house one or more motors with an air duct 707. In operation, incoming air 711 may flow over a bladder and may be directed by the diffuser node 709 in the direction of the counter rotating fan assembly 701, and out 713 through the air duct 707.

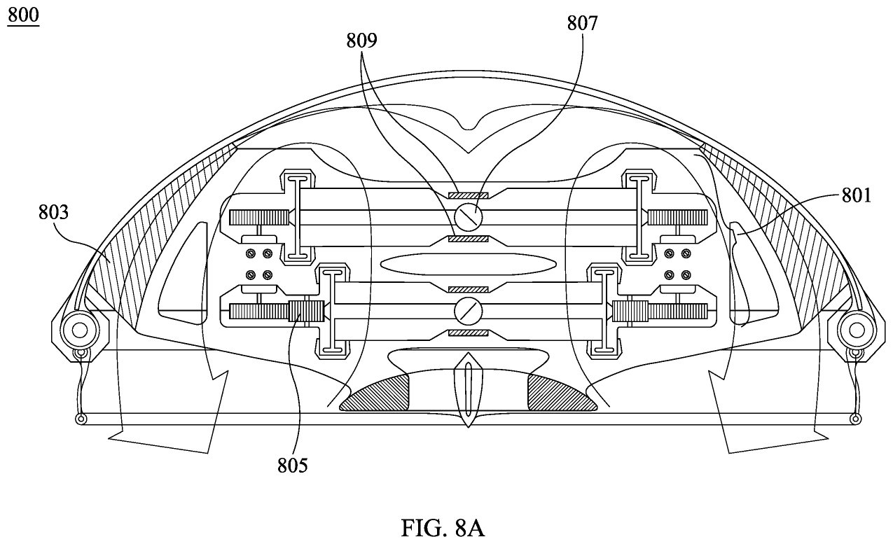

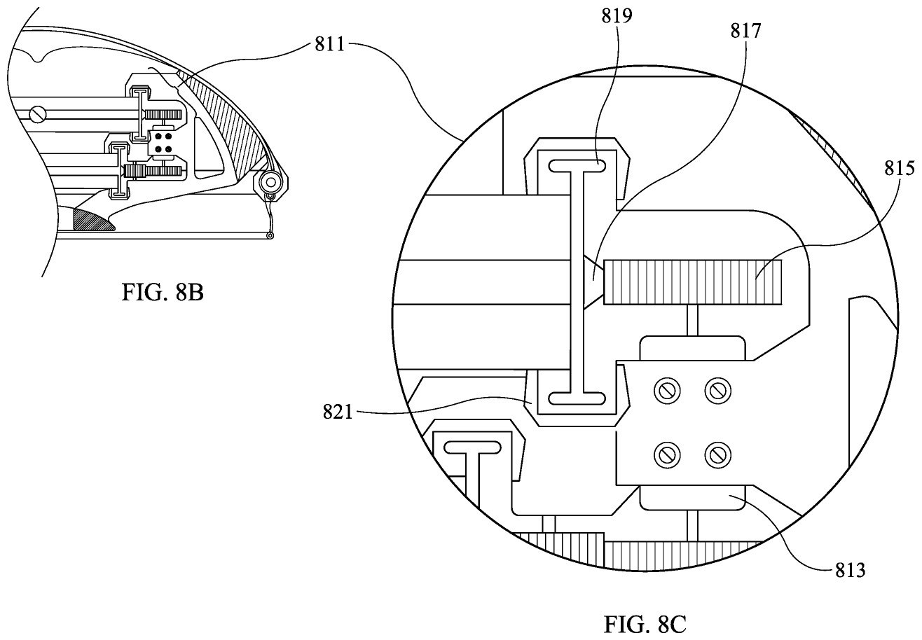

FIG. 8A shows another embodiment of an encapsulated drone 800 with a zero-point magnetic hub assembly 809 according to an exemplary embodiment of the present invention. The drone 800 may include a geared assembly 801 mounted with a structure held within the drone 800 by structural gussets 803. A step gear 805 may transfer power from a motor to a geared drive assembly, as discussed below. The drone 800 may further include a center weighted magnetic bearing 807 and a zero-point magnetic hub assembly 809.

FIGS. 8B and 8C show an exploded view detailing the geared assembly 811 of the zero-point magnetic hub assembly 809 of FIG. 8A. A motor 813, for example, a high output motor, may drive a motor drive gear 815 which may rotatably mate with a fan shroud geared collar 817. As noted above, a step gear 805 may be provided to transfer power from the motor 813. The zero-point magnetic hub assembly 809 may further include a fan shroud with magnetic caps 819 and a magnetic “C” channel collar 821.

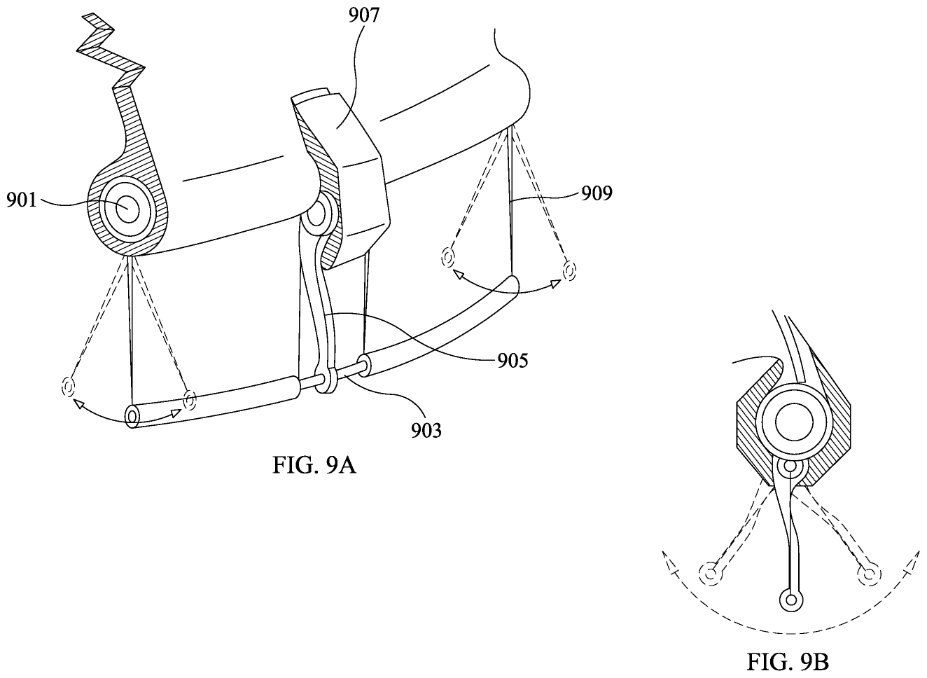

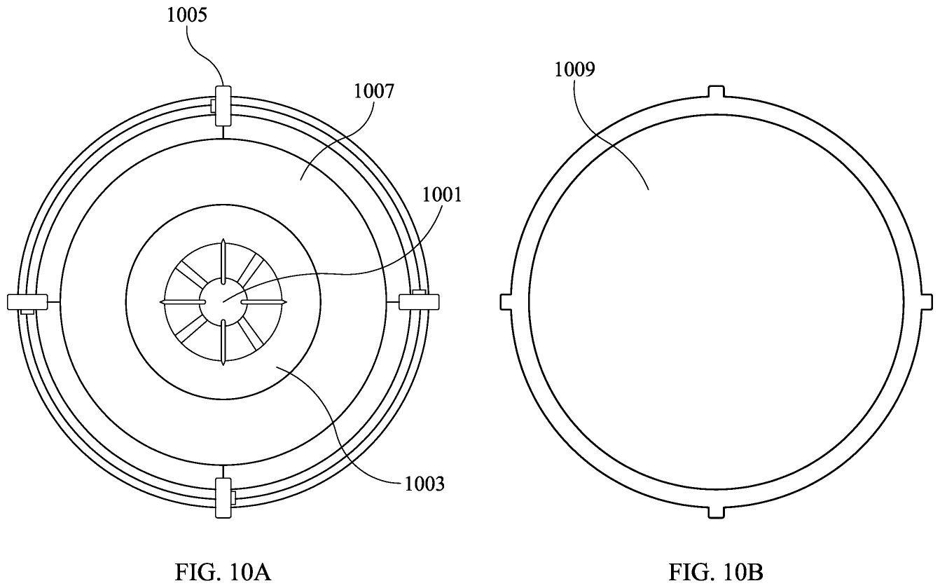

FIG. 9A is a schematic representation of a magnetic resonance power amplification (MRPA) pack 901 with a steering skirt 909, such as the battery 519 and the steering assembly 513 of FIG. 5A. The steering skirt 909 may be formed of a rigid hoop embedded in a trailing edge of the steering skirt 909 connected to a steering armature 905 attached to a motor 907, for example, a two axis servos motor. FIG. 9B is a side view of FIG. 9A showing a range of motion of the steering skirt 909 of FIG. 9A provided by motor 907.

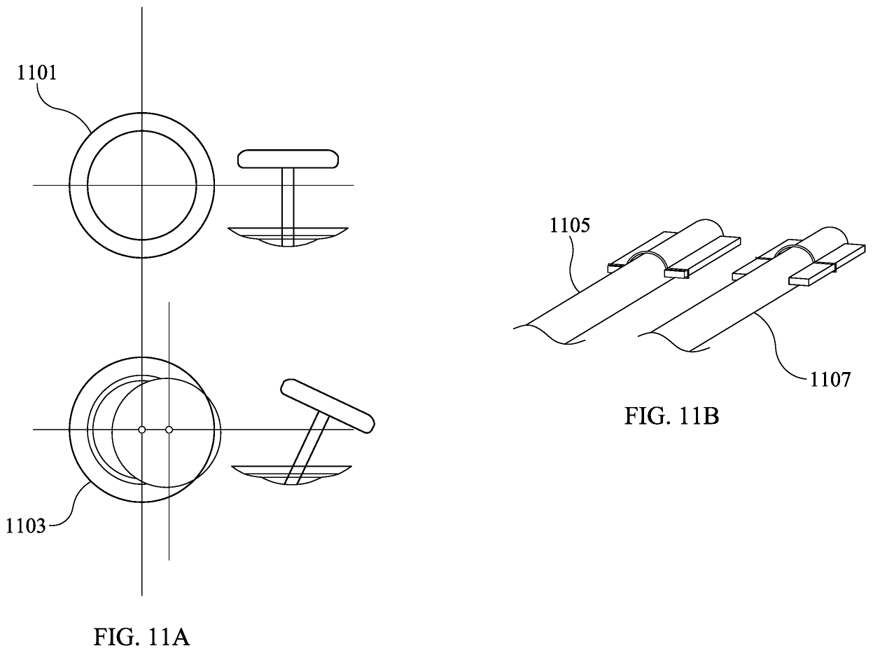

FIG. 10A is a bottom view of an exemplary drone 1000 revealing a rotating fly wheel 1001 and an inflatable bladder 1007, such as the fly wheel 517 and bladder 515 of FIG. 5A, according to an exemplary embodiment of the present invention. The drone 1000 may include a diffuser hub element 1003 and a steering assembly 1005 such as the steering assembly 513 of FIG. 5A. The drone 1000 may be encapsulated, that is, a shell 1009 may fully or substantially encapsulate the components of the drone 1000. FIG. 10B shows the exterior shell 1009 of the exemplary drone 1000 of FIG. 10A.

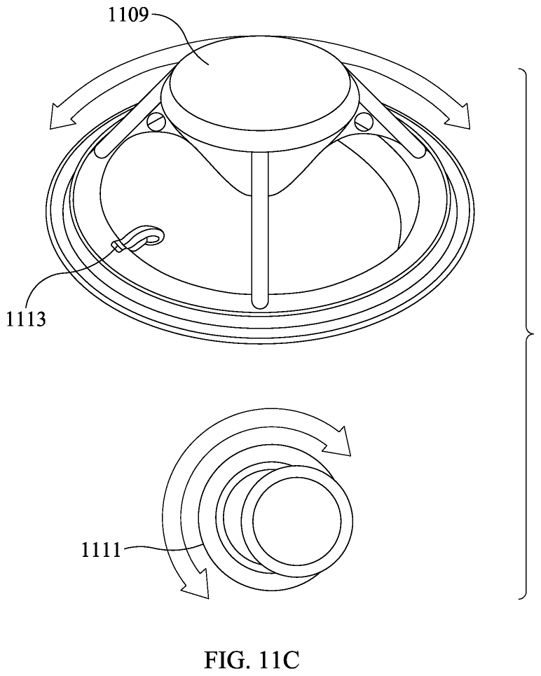

FIG. 11A-C show a joystick and a control arm in static and extended states that can control an exemplary drone according to an exemplary embodiment of the present invention. In 1101, a joystick control is shown in a static state while in 1103, the joystick control in shown in an extended state. In FIG. 11B, corresponding steering disc control arm states are shown. That is, in 1105, a steering disc control arm is shown in a static state corresponding to 1101, which in 1107, a steering disc control arm is shown in an extended state corresponding to 1103. In FIG. 11C, a steering assembly mating cone 1109 is shown with a hinge 1113, such as hinge 413 of FIG. 4A, and is rotating or counter rotating by, for example, a joystick control 1111.

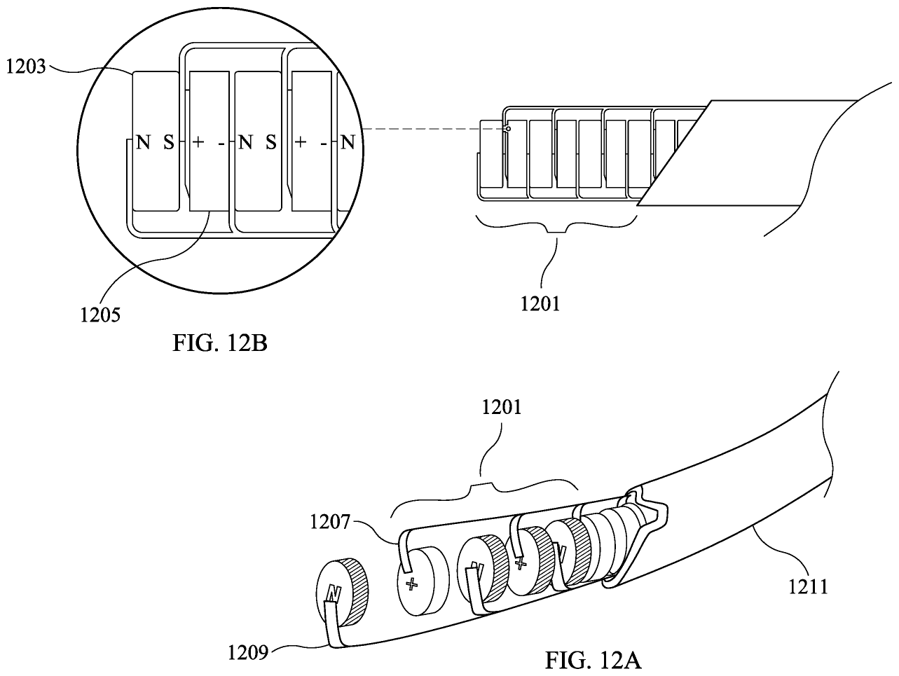

FIGS. 12A-B shows successively exploded views of the MRPA pack 1201 according to an exemplary embodiment of the present invention. The MRPA pack 1201 may include one or more neodymium magnets 1203 and one or more batteries 1205, such as 1.3 v batteries. The magnets 1201 and batteries 1203 may be arranged next to one another in a tube sleeve 1211. The tube sleeve may be formed of rubber. The magnets 1203 and batteries 1205 may be placed next to one another in an alternating manner with positive 1207 and negative 1209 leads inserted between.

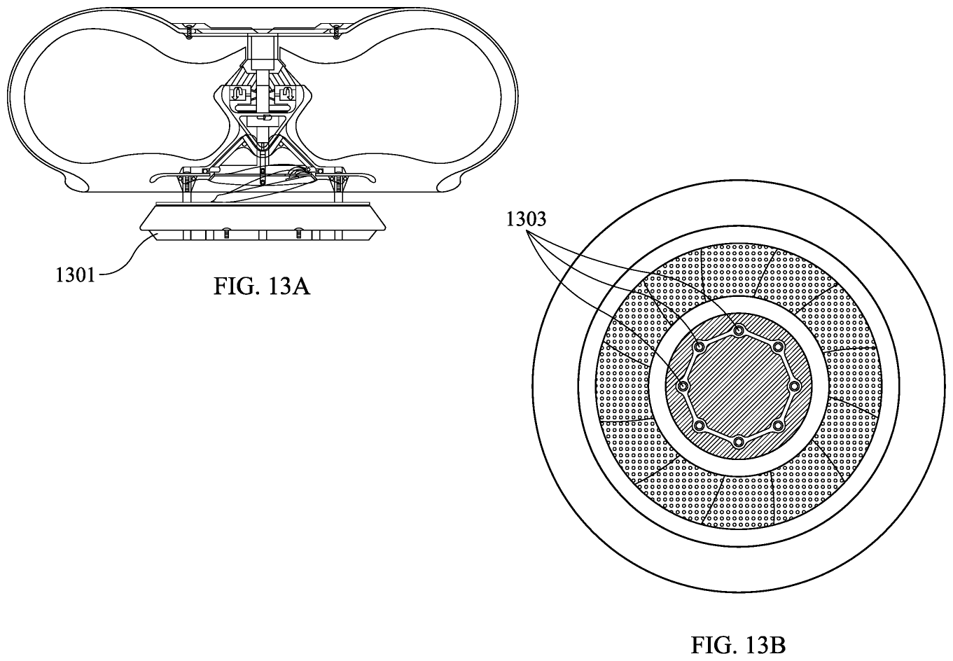

FIGS. 13A-B shows a payload mounting plate 1301 and exemplary holes 1303 for mounting said plate according to an exemplary embodiment of the present invention. The payload mounting plate 1301 may be mounted underneath or on the bottom of a power assembly housing, such as power assembly housing 113 of FIG. 1. Alternatively, a payload mounting plate 1301 may be mounted underneath or on the bottom of a drone, such as where a MRPA pack is provided. The holes 1303 may be mission specific or may be drawn to any appropriate standard.

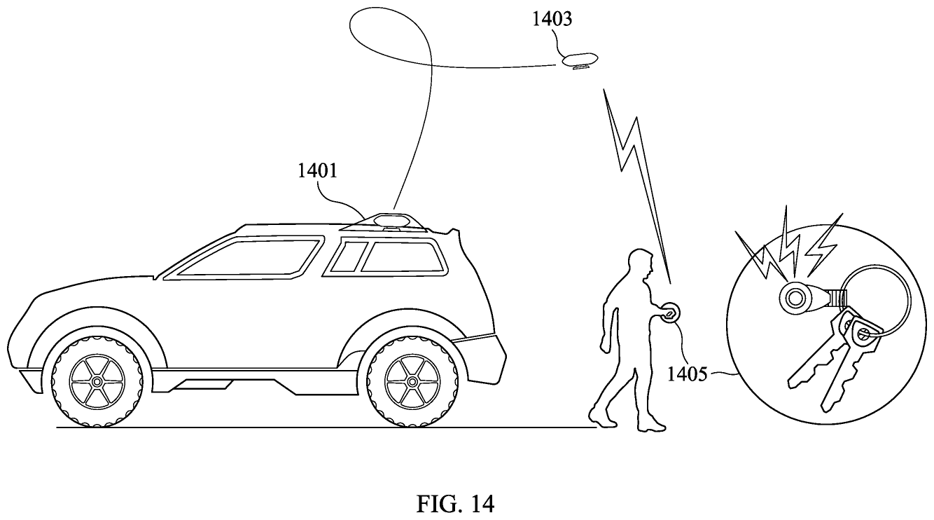

FIG. 14 is a schematic representation of a drone storage hub or nest 1401 according to an exemplary embodiment of the present invention. In operation, a drone 1403, such as drone 100 of FIG. 1, may be stored in the drone storage hub 1401 affixed to a vehicle. A charging portal may be provided within the drone storage hub 1401 or, while operational, in charging arrays or stations. The drone-storage hub 1401 or all weather “nest” may feature a charging station fitted with solar panels, power storage batteries, and diagnostic center for pre-flight check up and compatible with the vehicle's power system, which can be 12V. Said drone-storage hub 1401 may have a weather proof shell that covers and is fixed to a rigid substructure that is capable to be secured to a specified vehicle. Said drone-storage hub 1401 may also have emergency strobes and an automatic S.O.S. system that is transmitted through a communication link, including a “Sat Link” satellite communication phone system the operators can activate through a device, including a fob 1405 or Smartphone device. A drone 1403 used with the drone-storage hub 1401 may have a proximity awareness algorithm that will use GPS to establish the location of said hub, whether dynamic located or static or a ‘follow me’ features that may allow this embodiment to constantly visually monitor an area perimeter, including one, for example, 30 meters in diameter in proximity of the user such that said algorithm can include accepting current weather conditions, terrain mapping avoidance, and hostile wild-life alert features as well as all other entertainment based applications. During storage, the drone 1401 may mate with the storage portal. A key ring fob 1405 may provide user control commands for transport to the drone 1403. The key ring fob 1405 may provide additional features. For example, should the user get seriously injured, the user could activate a panic button on a fob worn around the neck, and the drone may automatically send a SOS distress signal through a satellite phone system that is part of the nest communication system. The drone may have the ability to remain with the user transmitting real time video feed as well as bio feedback to include; respiration, heartbeat, and other vital medical information that may be needed for a proper medical emergency assessment.

Embodiments of the present invention provide a drone mostly, if not entirely encapsulated by a multi-dimensionally protective shell while exposing only small/slim areas for intake, output, and steering functionality. Embodiments provide an advanced platform built to endure long flight periods and provide the ability to carry heavy payloads, quietly and efficiently. The embodiments provide for several benefits. For example, traditional anti-drone efforts are rendered less effective if not completely ineffective. Further defensive or offensive measures may include ramming of other drones (such as the rotor blades of other drones) and firing of an air to air missile. Mid-air electronics jamming or launching of a disc that can trigger a controlled or focused microburst or an Electromagnetic Pulse (EMP) may be possible due to The foregoing description discloses only exemplary embodiments of the invention. Modifications of the above-disclosed embodiments of the present invention (beyond those modifications already mentioned) of which fall within the scope of the claims will be readily apparent to those of ordinary skill in the art.

Accordingly, although embodiments of the present invention have been shown and described, it would be appreciated by those skilled in the art that changes may be made in these embodiments without departing from the principles and spirit of the invention.

What is claimed is:

1. An encapsulated drone, comprising:
a shell of the encapsulated drone, and
a drive assembly at least substantially encapsulated by the shell, the drive assembly including:
at least one motor; and
a plurality of rotors powered by the at least one motor.

2. The encapsulated drone of claim 1, wherein the shell comprises an opening in a center top portion of the shell, the opening in the center top portion defining an air input positioned above the drive assembly.

3. The encapsulated drone of claim 2, further comprising a steering disc positioned below the drive assembly.

4. The encapsulated drone of claim 3, wherein the steering disc is movably attached to the encapsulated drone via one or more of a hinge arm, a control arm, and a control link.

5. The encapsulated drone of claim 3, wherein the steering disc, either alone or in combination with additional steering disc components, and a lower portion of the shell form a ring-shaped opening below the plurality of rotors, the ring-shaped opening defining an exhaust for downward airflow from the plurality of rotors.

6. The encapsulated drone of claim 5, further comprising one or more openings above said steering disc, said one or more openings defining a steering exhaust configured to direct airflow from the plurality of rotors over the steering disc.

7. The encapsulated drone of claim 6, further comprising a linear rotary motor configured to rotate the steering disc.

8. The encapsulated drone of claim 1, wherein the at least one motor is reconfigurable between 2 to 8 motors.

9. The encapsulated drone of claim 1, wherein the plurality of rotors forms a first replaceable set, and wherein a second replaceable set may be substituted for the first replaceable set.

10. The encapsulated drone of claim 1, wherein the plurality of rotors are adjustable in terms of one or more of pitch and effective surface size.

11. The encapsulated drone of claim 10, wherein the plurality of rotors are mounted along at least two hub assembly subcomponents adjustable to each other, thereby forming an upper rotor layer and a lower rotor layer that are adjustable to each other.

12. The encapsulated drone of claim 1, further comprising a steering assembly including a flexible skirt attached to an outer perimeter of the encapsulated drone.

13. The encapsulated drone of claim 1, further comprising a ring-shaped bladder configured to compress incoming airflow into outgoing airflow.

14. The encapsulated drone of claim 1, further comprising a shroud covering at least a portion of the shell.

15. The encapsulated drone of claim 14, wherein the plurality of rotors forms an interior fan assembly and wherein a second fan assembly is provided as an exterior fan assembly or shroud fan assembly.

16. The encapsulated drone of claim 1, wherein the plurality of rotors and a second set of rotors form a counter rotating fan assembly.

17. The encapsulated drone of claim 1, wherein the drive assembly is a zero-point gravity drive assembly, comprising:
a magnetic matrix retaining a magnetic field;
a shaft having a magnetic ball at each end, each magnetic ball being within the magnetic field of the magnetic matrix; and
one or more magnetic bearings around the shaft.

18. A method of producing an encapsulated drone, the method comprising:
providing a drive assembly including:
at least one motor; and
a plurality of rotors powered by the at least one motor; and
providing a shell at least substantially encapsulating the drive assembly.

19. The encapsulated drone of claim 1, wherein said shell is expandable.

20. The encapsulated drone of claim 19, further comprising an inflatable bladder connected to rigid tiles forming said shell, wherein upon inflation of said inflatable bladder, said shell expands by said rigid tiles moving apart from each other.

21. The encapsulated drone of claim 1, further comprising one or more thrust nozzles arranged at an outer edge the shell.

22. An encapsulated drone, comprising:
an expandable shell of the encapsulated drone, the expandable shell being formed at least partially of one or more rigid components connected to an expandable member; and
a drive assembly at least substantially encapsulated by the expandable shell, the drive assembly including:
at least one motor; and
a plurality of rotors powered by the at least one motor.

23. The encapsulated drone of claim 22, wherein the one or more rigid components comprises a plurality of tiles connected to the expandable member, and wherein the expandable member comprises an inflatable bladder.

24. The encapsulated drone of claim 23, further comprising one or more gas cartridges connected to the inflatable bladder via one or more check valves, the one or more gas cartridges containing a gas to inflate the inflatable bladder.

25. The encapsulated drone of claim 22, wherein the plurality of rotors are each adjustable in terms one or more of the group including effective surface area and pitch.

26. The encapsulated drone of claim 22, wherein the plurality of rotors comprise an upper layer of rotors adjustable relative to a lower layer of rotors between a narrow configuration wherein the upper layer of rotors are directly above the lower layer of rotors and an expanded configuration wherein the upper layer of rotors are offset from the lower layer of rotors.

27. The encapsulated drone of claim 26, wherein one or more openings on the bottom of the encapsulated drone defining an exhaust configured to direct airflow from one or both of the upper layer of rotors and lower layer of rotors.

28. The encapsulated drone of claim 22, further comprising one or more thrust nozzles arranged at an outer edge of the encapsulated drone.

29. An encapsulated drone, comprising:
a plurality of rigid components connected to an inflatable bladder thereby forming at least a portion of an expandable shell;
one or more gas cartridges connected to the inflatable bladder via one or more check valves, the one or more gas cartridges containing a gas to inflate the inflatable bladder;
a drive assembly at least substantially encapsulated by the expandable shell, the drive assembly including:
at least one motor;
an upper layer of rotors and a lower layer of rotors, wherein the upper and lower layers of rotors are adjustable relative to each other between a narrow configuration wherein the upper layer of rotors are directly above the lower layer of rotors and an expanded configuration wherein the upper layer of rotors are offset from the lower layer of rotors;
one or more openings on the bottom of the encapsulated drone defining an exhaust configured to direct airflow from one or both of the upper layer of rotors and lower layer of rotors; and
one or more thrust nozzles arranged at an outer edge of the encapsulated drone.
